(19) United States
(12) Patent Application Publication
(10) Pub. No.: US 2007/0062083 A1
(43) Pub. Date: Mar. 22, 2007

(54) Fastening structure for decorative plate

(76) Inventor: Chih-Lung Lin, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/229,341

(22) Filed: Sep. 16, 2005

(51) Int. Cl. G09F 13/00

(52) U.S. Cl. 40/541

(57) ABSTRACT

A fastening structure for a decorative plate includes a decorative plate and a connecting support. A plurality of male elements and female elements are provided on the decorative plate and connecting support, respectively, for fastening the decorative plate to the connecting support, such that an inside space is formed therebetween for erecting the decorative plate.

### BACKGROUND OF THE INVENTION

1. Field of the Invention

The present invention relates to a fastening structure for a decorative plate.

2. The Prior Arts

Generally speaking, there are many decorative plates available in the market on which lovable figures and patterns are provided. Such decorative plates are located at the places in which many kids appear, such as kindergartens and pediatric clinics. It is found that the decorative plates in the foregoing places are provided almost by sticking or hanging on a wall.

Sticking the decorative plates on a wall has some drawbacks. Original paints or decorations on the wall will be damaged more or less and ugly marks are inevitably left when the stuck decorative plates are detached from the wall. On the other hand, the decorative plates hung on the wall are liable to swing or fall from the wall.

The above two ways are conventionally used in the decorative plates. No matter the sticking or hanging is used, it is short of three-dimensional effect. Therefore, some toy merchants try to overcome the above drawback (three-dimensional effect) by mounting a connecting support on a back thereof, such that the decorative plates can be erected. In this way, the decorative plates are not limited to locate on a plane or a wall any more.

However, since the existing connecting interface for connecting the decorative plates and the connecting support still lacks a fastening structure, which is easy to attach/detach, light in weight, and liable to get, it is meaningful to develop a fastening structure meeting the above requirements.

### SUMMARY OF THE INVENTION

The object of the present invention is to provide a fastening structure for a decorative plate, which is easy to be attached/detached with a small force and can be supported and erected by the fastening structure to increase three-dimensional effect of the decorative plate.

The other object of the present invention is to provide a fastening structure for a decorative plate, which has an inside space for receiving decorative bulbs, batteries and wires without being exposed to the outside and spoiling the appearance.

Further, since the inside space is formed between the decorative plate and the connecting support, if small bulbs are additionally mounted therein, the decorative plate seems to be more beautiful and even has an embellishing effect at dark. By providing fixing clips on the connecting support, the decorative bulbs can be easily attached to and detached from the connecting support. Further, whether the decorative bulbs are attached/detached or not may be determined according to users' demands.

Further, a front of the decorative plate of the present invention can be formed as different patterns to increase the feeling of freshness. In other word, the fastening structure of the present invention can be repeatedly used in different patterns of the decorative plates, such that users need not to buy another fastening structure for arranging new patterns. Thus, unnecessary waste can be prevented and environment protection can also be achieved.

Further, since the present invention may be made of plastic materials, it is easy to get and be manufactured. Due to being lightweight and easy detachment, the present invention can be widely applied not only to the decorative plate but also to any fastening devices.

Since the decorative plate of the present invention is connected and fastened by the fastening structure, the more the number of male and female elements used, the greater the connecting force. If the fastening structure is painted by various colors, the decorative plate may be very colorful and exhibit more feelings of beauty and added values.

### BRIEF DESCRIPTION OF THE DRAWINGS

The present invention will be apparent to those skilled in the art and easy to be carried out by reading the following detailed description of a preferred embodiment thereof with reference to the attached drawings, in which:

FIG. 1 is an exploded perspective view of a fastening structure for a decorative plate in accordance with the present invention.

FIG. 2 is a perspective view showing a back of a single-faced decorative plate in accordance with an embodiment of the present invention.

FIG. 3 is a perspective view showing a front of the single-faced decorative plate of the present invention.

FIG. 4 is an exploded perspective view showing a fastening structure for a double-faced decorative plate in accordance with another embodiment of the present invention.

FIG. 5 is an exploded perspective view of the fastening structure for the decorative plate of the present invention, in which decorative bulbs are additionally mounted.

### DETAILED DESCRIPTION OF THE PREFERRED EMBODIMENT

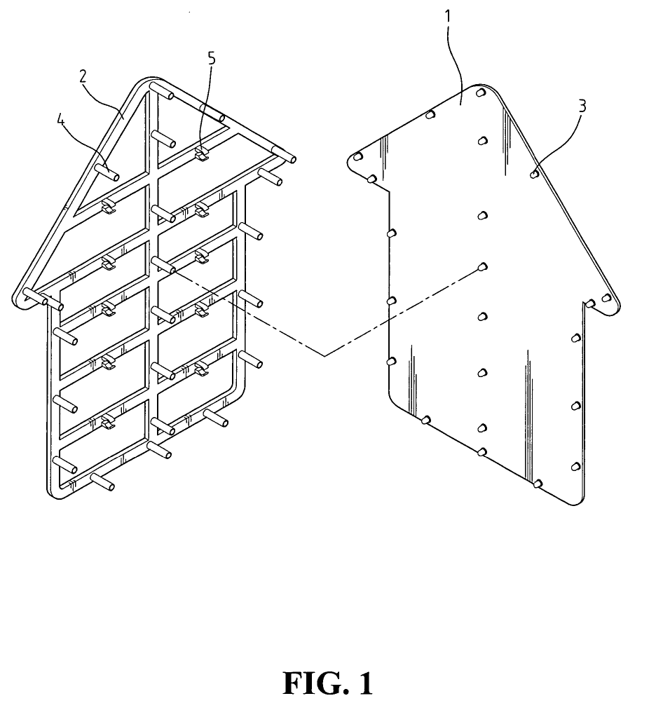

First, referring to FIG. 1, in accordance with a preferred embodiment of the present invention, a decorative plate 1 made by plastic material and a connecting support 2 are provided. A plurality of male elements 3 are inserted into one surface of the decorative plate 1. Each of the male elements 3 is formed as a cylinder. A plurality of female elements 4 are inserted into the connecting support 2 at the places corresponding to the male elements 3, respectively. Each of the female elements 4 is formed as a hollow cylinder. The radius of the hollow cylinders of the female elements 4 is slightly larger than that of the male elements 3, such that the male elements 3 can be received in the female elements 4. Further, a plurality of fixing clips 5 are provided on the connecting support 2 for attaching and fixing decorative bulbs thereon.

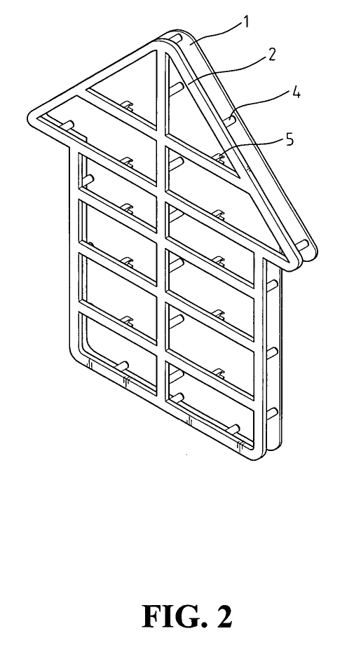

Next, with reference to FIG. 2, the decorative plate 1 is fastened to the connecting support 2 by male and female elements 3, 4. Since the female elements 4 are formed as a cylinder, the length thereof can be increased or decreased to a proper extent depending on users' demands. In this way, the decorative plate can be integrally erected.

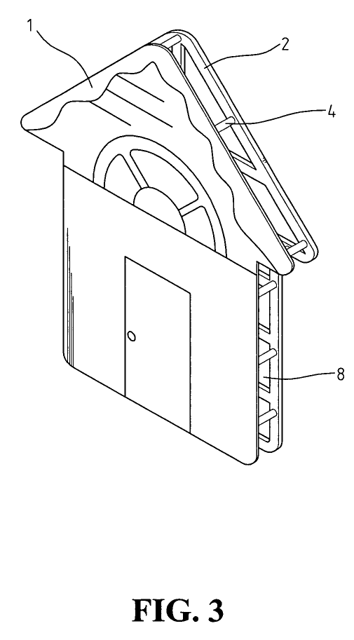

Next, with reference to FIG. 3, a pattern of a lovely small cabin is depicted on the decorative plate 1. The small cabin has three-dimensional effect due to the thickness of the fastening structure. If an inside space 8 therebetween is provided with decorative bulbs and wires along the connecting support 4, the decorative plate seems to be more beautiful without exposing the wires to the outside to spoil the appearance.

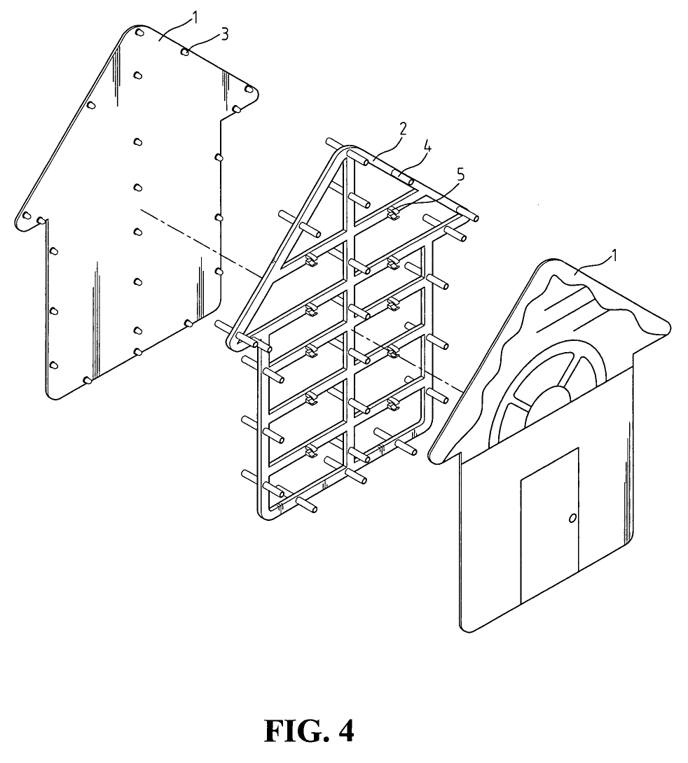

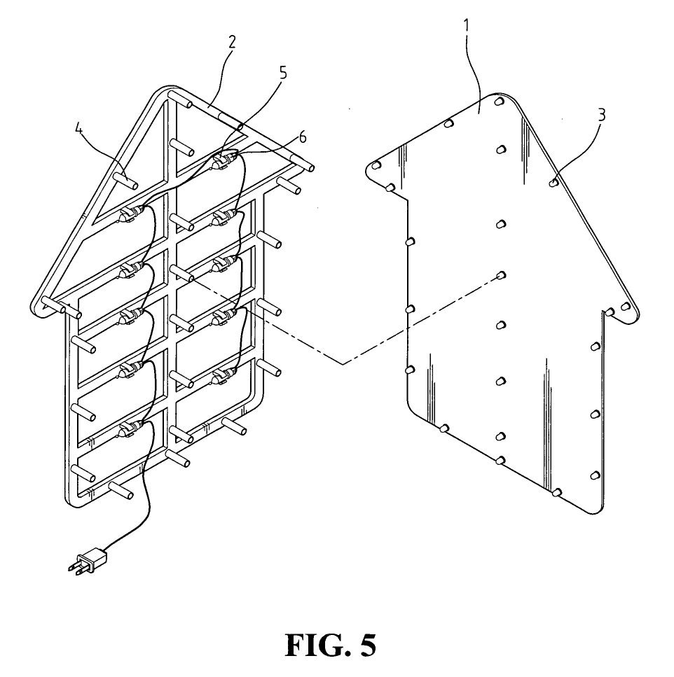

Referring to FIG. 4, both sides of the connecting support 2 are provided with a plurality of female elements 4. A decorative plate 1 having a small cabin pattern is provided on each side of the connecting support 2, respectively. Therefore, the double-faced decorative plate has a better three-dimensional effect than the single-faced decorative plate. Further, it is more stable than the single-faced decorative plate and not liable to be blown off by wind. The double-faced decorative plate has a larger inside space than the single-faced decorative plate, such that decorative bulbs and wires can be provided therein. FIG. 5 illustrates decorative bulbs 6 are mounted on the fixing clips 5.

The fastening structure of the present invention is used to connect the decorative plate 1 and the connecting support 2. All of the members can be made of plastic materials, metals or other materials according to users' demands and purposes.

Further, the small cabin pattern can be replaced by other patterns to increase the feeling of freshness. Of course, the present invention is not limited to only decorative purpose. For example, the decorative plate 1 can be made of transparent plastic plates. In this way, a warning pattern can be stuck on a front of the decorative plate, and twinkling bulbs can be provided in the inside space to become a warning signal. Such a warning signal can be used in camping or construction sites.

The above description is merely used to explain the preferred embodiments of the present invention, but not intended to limit the present invention. Therefore, it should be understood that any modification or change without departing from the scope and spirit of the present invention still falls into the scope encompassed by the present invention.

What is claimed is:

1. A fastening structure for a decorative plate, comprising:
a decorative plate;
a connecting support; and
a plurality of transverse rods connected between the decorative plate and the connecting support.

2. The fastening structure for a decorative plate according to claim 1, wherein one end of the transverse rods is integrally extended from the connecting support, and the other end thereof is fastened to the decorative plate by male and female elements.

3. The fastening structure for a decorative plate according to claim 1, wherein one end of the transverse rods is integrally extended from the decorative plate, and the other end thereof is fastened to the connecting support by male and female elements.

4. The fastening structure for a decorative plate according to claim 1, wherein both ends of the transverse rods are fastened to the decorative plate and the connecting support by male and female elements.

5. The fastening structure for a decorative plate according to claim 1, wherein the transverse rod is integrally connected between the decorative plate and the connecting support.

6. The fastening structure for a decorative plate according to claim 1, wherein a plurality of fixing clips are provided on the connecting support for clipping decorative bulbs.

7. The fastening structure for a decorative plate according to claim 1, wherein a plurality of transverse rods are provided on a front and a back of the connecting support, and the front and back of the connecting support are connected with a decorative plate, respectively.

8. The fastening structure for a decorative plate according to claim 1, wherein a pattern is arranged on the front of the decorative plate.

9. The fastening structure for a decorative plate according to claim 1, wherein the fastening structure is made of plastic materials.

10. The fastening structure for a decorative plate according to claim 1, wherein the fastening structure is made of metals.
